(19) United States
(12) Patent Application Publication
(10) Pub. No.: US 2012/0092482 A1
(43) Pub. Date: Apr. 19, 2012

(54) METHOD AND DEVICE FOR CREATING COMPOSITE IMAGE

(76) Inventors: Shinichi Shinoda, Hitachi (JP); Yasutaka Toyoda, Mito (JP); Ryoichi Matsuoka, Yotsukaido (JP)

(21) Appl. No.: 13/262,734

(22) PCT Filed: Apr. 2, 2010
(86) PCT No.: PCT/JP2010/056062

§ 371 Date: Dec. 23, 2011

(30) Foreign Application Priority Data
Apr. 3, 2009 (JP) 2009-091390

(51) Int. Cl. G06K 9/36; H04N 7/18

(52) U.S. Cl. 348/80; 382/284; 348/E07.085

(57) ABSTRACT

A composite image creating method and device are provided which, when images separately captured a plurality of times are panoramically synthesized, can prevent deformation of a pattern due to multiple irradiation of the electron beam. One image is generated by overlapping joining areas of rims of two adjacent images when a plurality of images are joined to generate one image. Of two adjacent images, the joining area of an image of an earlier image capturing order is left, and the joining area of an image of a later image capturing order is removed. The joining area of the image of an earlier image capturing order is obtained with irradiation of electron beam a less number of times than the joining area of the image of a later image capturing order, and therefore deformation of a pattern due to irradiation of the electron beam is little.

### TECHNICAL FIELD

The present invention relates to a technique of inspecting a pattern by means of, for example, an electronic microscope, and, more particularly, relates to a technique of panoramic synthesis for generating one image by synthesizing a plurality of images.

### BACKGROUND ART

Conventionally, a critical-dimension scanning electron microscope (CD-SEM) has been widely used to inspect results of precise wiring patterns formed on semiconductor wafers. Recently, with miniaturization of process for semiconductor devices, products of process nodes of 45 nm have been mass-produced. With miniaturization of wiring patterns, defects which need to be detected become small. Hence, the image capturing magnification of CD-SEM should be higher.

Recently, with miniaturization of wiring patterns, there is a problem that a pattern deforms due to an optical proximity effect. Therefore, optical proximity correction (OPC) is performed. The OPC simulation is performed to optimize OPC. According to the OPC simulation, an image of a wiring pattern of a mask or wafer formed by performing OPC is captured, and its image data is fed back to the OPC simulation. Thus, higher precision of the OPC simulation and improvement precision are realized.

The captured image to be fed back to the OPC simulation requires an area of about 2 micrometers*2 micrometers to 8 micrometers*8 micrometers at a high magnification. The captured image has several thousand pixels when one pixel has a resolution of 1 nm.

To acquire an image at a high magnification in a wide range, it is only necessary to increase the number of pixels of an imaging system to capture images in the wide range or capture images a plurality of times and then panoramically synthesize the images. Japanese Patent Application Laid-Open No. 61-22549 discloses a panoramic synthesizing method.

In an electronic microscope, an image capturing target is irradiated with an electrode beam to detect secondary electrons from the image capturing target and to generate an electronic image. Therefore, when the image capturing target is a wafer, it is known that irradiation of the electron beam shrinks a resist and deforms a pattern. To reduce deformation of a pattern such as shrinkage, it is necessary to adjust, for example, the amount of the electron beam. Japanese Patent Application Laid-Open No. 2008-66312 discloses a method of adjusting, for example, the amount of the electron beam.
Patent Document 1: Japanese Patent Application Laid-Open No. 61-22549
Patent Document 2: Japanese Patent Application Laid-Open No. 2008-66312

### DISCLOSURE OF THE INVENTION

### Problems to be Solved by the Invention

According to panoramic synthesis, when a plurality of images is joined, images are joined such that the rim of an image overlaps the rim of an adjacent image. Hence, an area on an image capturing target corresponding to an image joining area is irradiated with the electron beam a plurality of times. When an image capturing target is a wafer, multiple irradiation of the electron beam shrinks a resist and deforms a pattern. Even if this image data is fed back to the OPC simulation, it is not possible to improve precision of the OPC simulation.

Such deformation of a pattern varies depending on, for example, the electron beam amount, a material of a resist and a pattern shape, and is hard to be predicted.

It is therefore an object of the present invention to provide a composite image creating method and device which, when images separately captured a plurality of times are panoramically synthesized, can prevent deformation of a pattern due to multiple irradiation of the electron beam.

### Means for Solving the Problems

The present invention generates one image by overlapping joining areas of rims of two adjacent images when a plurality of images are connected to generate one image. Of two adjacent images, the joining area of an image of an earlier image capturing order is left, and the joining area of an image of a later image capturing order is removed. The joining area of the image of an earlier image capturing order is obtained with irradiation of electron beam a less number of times than the joining area of the image of a later image capturing order, and therefore deformation of a pattern due to irradiation of the electron beam is little.

The present invention corrects deformation of a pattern due to irradiation of the electron beam in the joining area of the image of an earlier image capturing order. The relationship between the number of times of irradiation of the electron beam and a deformation amount of the pattern is calculated in advance. The pattern in the joining area is corrected on the basis of this pattern deformation information.

### Advantages of the Invention

The present invention provides an imaging device and imaging method which, when images separately captured a plurality of times are panoramically synthesized, can prevent deformation of a pattern due to multiple irradiation of the electron beam. It is possible to prevent deformation of a pattern due to image capturing and acquire precisely connected images.

### BRIEF DESCRIPTION OF THE DRAWINGS

FIG. 1 is a view illustrating a configuration example of a composite image creating device according to the present invention.

FIG. 2 is a view illustrating another configuration example of a composite image creating device according to the present invention.

FIG. 3 is a view illustrating an example of data stored in an image capturing order information storing unit and an image capturing position information storing unit of the composite image creating device according to the present invention.

FIG. 4 is a view illustrating an example of data stored in a deformation information storing unit of the composite image creating device according to the present invention.

FIG. 5 is a view illustrating a configuration example of an image synthesizing unit of an image processing unit of the composite image creating device according to the present invention.

FIG. 6 is a view illustrating a configuration example of a deformation correcting unit of the image synthesizing unit of the image processing unit of the composite image creating device according to the present invention.

FIG. 7A is a view illustrating a concept of a joining area of an image in the image synthesizing unit of the image processing unit of the composite image creating device according to the present invention.

FIG. 7B is a view illustrating a concept of a joining area of an image in the image synthesizing unit of the image processing unit of the composite image creating device according to the present invention.

FIGS. 8A and 8B are views describing a joining area of an image in the image synthesizing unit of the image processing unit of the composite image creating device according to the present invention.

FIG. 9 is a view illustrating processing of calculating the number of times of irradiation of an electron beam in the composite image creating device according to the present invention.

FIG. 10 is a view illustrating a configuration example of a pattern site detecting unit of a deformation correcting unit of the image synthesizing unit of the image processing unit of the composite image creating device according to the present invention.

FIG. 11A is a view illustrating a concept of a detecting method of a pattern site in a pattern site detecting unit according to the present invention.

FIG. 11B is a view illustrating a concept of a detecting method of a pattern site in the pattern site detecting unit according to the present invention.

FIG. 11C is a view illustrating a concept of a detecting method of a pattern site in the pattern site detecting unit according to the present invention.

FIG. 12A is a view illustrating a concept of a method of calculating the deformation amount of data stored in the deformation information storing unit of the composite image creating device according to the present invention.

FIG. 12B is a view illustrating a concept of a method of calculating the deformation amount of data stored in the deformation information storing unit of the composite image creating device according to the present invention.

FIG. 13 is a view illustrating a configuration example of a correcting unit of the deformation correcting unit of the image synthesizing unit of the image processing unit of the composite image creating device according to the present invention.

FIG. 14 is a view illustrating a configuration example of an area extracting unit of the correcting unit according to the present invention illustrated in FIG. 13.

FIG. 15 is a view illustrating a configuration example of a closed figure filling unit of the area extracting unit of the correcting unit according to the present invention illustrated in FIG. 14.

FIG. 16A is a view illustrating a concept of finding a closed figure of a pattern in the closed figure filling unit according to the present invention illustrated in FIG. 14.

FIG. 16B is a view illustrating a concept of finding a closed figure of a pattern in the closed figure filling unit according to the present invention illustrated in FIG. 14.

FIG. 17 is a view illustrating a configuration example of an area copy deforming unit of the correcting unit according to the present invention illustrated in FIG. 13.

FIG. 18A is a view describing bilinear interpolation processing in an area copy deforming unit according to the present invention illustrated in FIG. 17.

FIG. 18B is a view describing bilinear interpolation processing in an area copy deforming unit according to the present invention illustrated in FIG. 17.

FIG. 19 is a view illustrating a configuration example of an image pasting unit of the image synthesizing unit of the image processing unit of the composite image creating device according to the present invention.

FIG. 20 is a view illustrating processing of capturing an image of each area by dividing an image capturing target into 16 areas.

FIG. 21 is a view illustrating processing of joining processing in the image synthesizing unit of the image processing unit of the composite image creating device according to the present invention.

FIG. 22 is a view illustrating a concept of calculating the number of times of irradiation of an electron beam on a joining area upon image pasting in a composite image creating method according to the present invention.

FIG. 23 is a view illustrating a concept of deformation of a pattern of an electronic device of an image capturing target due to irradiation of an electron beam.

FIG. 24 is a view illustrating another configuration example of a composite image creating device according to the present invention.

FIG. 25 is a view describing another example of a panoramic image synthesizing method according to the present invention.

FIG. 26 is a flowchart describing process of determining a pattern edge which needs to be left on the basis of a predetermined setting for overlapping areas of image capturing areas in the panoramic image synthesizing method according to the present invention.

### DESCRIPTION OF SYMBOLS

1 . . . IMAGE MEMORY
2 . . . IMAGE SYNTHESIZING UNIT
3 . . . IMAGE CAPTURING ORDER INFORMATION STORING UNIT
4 . . . DEFORMATION INFORMATION STORING UNIT
5 . . . IMAGE CAPTURING POSITION INFORMATION STORING UNIT
6 . . . DESIGN DATA STORING UNIT
7 . . . DEFORMATION INFORMATION GENERATING UNIT
11 . . . IMAGING DEVICE
12 . . . IMAGE CAPTURING CONTROL DEVICE
13 . . . IMAGE PROCESSING UNIT
21 . . . CORRECTED IMAGE SELECTING UNIT
22 . . . DEFORMATION CORRECTING UNIT
23 . . . IMAGE PASTING UNIT
24 . . . JOINING AREA DETECTING UNIT
25 . . . PATTERN SITE DETECTING UNIT
26 . . . CORRECTING UNIT
27 . . . ELECTRON BEAM IRRADIATION COUNT CALCULATING UNIT
28 . . . IMAGE STORING UNIT
231 . . . MATCHING PROCESSING UNIT
232 . . . SYNTHESIZING UNIT
251 . . . SMOOTHING PROCESSING UNIT
252 . . . BINARIZATION PROCESSING UNIT
253 . . . EXPANSION PROCESSING UNIT
254 . . . MATCHING PROCESSING UNIT
255 . . . TEMPLATE PATTERN STORING UNIT
256 . . . EXPANSION PROCESSING UNIT
261 . . . SMOOTHING PROCESSING UNIT
262 . . . BINARIZATION PROCESSING UNIT
263 . . . AREA EXTRACTING UNIT
264 . . . AREA COPY DEFORMING UNIT
265 . . . IMAGE PASTING PROCESSING UNIT
266 . . . CONNECTION COMPONENT EXTRACTING UNIT
267 . . . CLOSED FIGURE FILLING UNIT
268 . . . EXPANSION PROCESSING UNIT
2671 . . . CONNECTION COMPONENT SELECTING UNIT
2672 . . . CLOSED FIGURE GENERATING UNIT
2673 . . . FILLING UNIT
2641 . . . IMAGE SELECTING UNIT
2642 . . . BILINEAR INTERPOLATING UNIT
2643 . . . STORING UNIT
s0 . . . POSITION INFORMATION
s1 . . . IMAGE DATA
s2 . . . PATTERN SITE
s3 . . . DEFORMATION AMOUNT MEASUREMENT POSITION

### BEST MODE FOR CARRYING OUT THE INVENTION

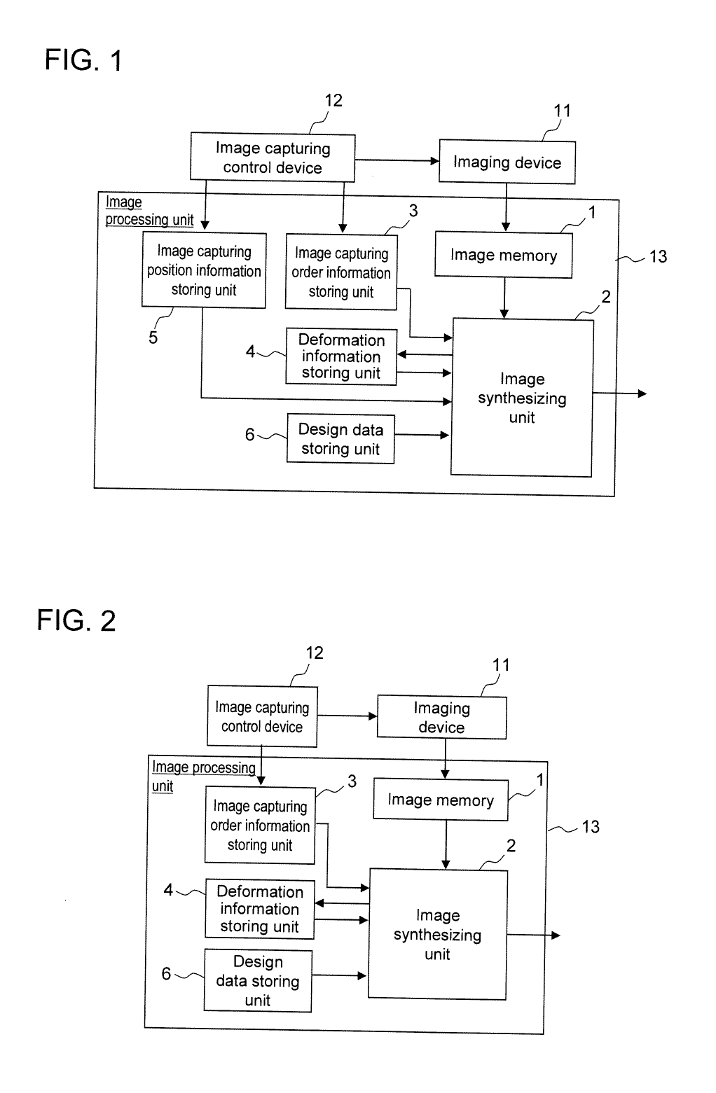

A configuration of a first example of a composite image creating device according to the present invention will be described with reference to FIG. 1. The composite image creating device according to this example has an imaging device 11, an image capturing control device 12 and an image processing unit 13. The image processing unit 13 has an image memory 1, an image synthesizing unit 2, an image capturing order information storing unit 3, a deformation information storing unit 4, an image capturing position information storing unit 5 and a design data storing unit 6.

The imaging device 11 may be a scanning electron microscope (SEM) or critical-dimension scanning electron microscope (CD-SEM). In the scanning electron microscope, a mask or wafer of an image capturing target is irradiated with an electron beam, to detect a secondary electron discharged therefrom and to acquire image data. The composite image creating device according to the present invention separately captures images of a pattern of an image capturing target a plurality of times, and synthesizes the images to generate one image. Consequently, a plurality of divided images is acquired as image data. When one pattern is divided into nine, nine items of divided image data are acquired. The image capturing control device 12 sets image capturing positions and an image capturing order of a plurality of divided images.

The image memory 1 stores image data acquired by the imaging device 11. When, for example, one pattern is divided into nine and captured, nine divided images are stored in the image memory 1.

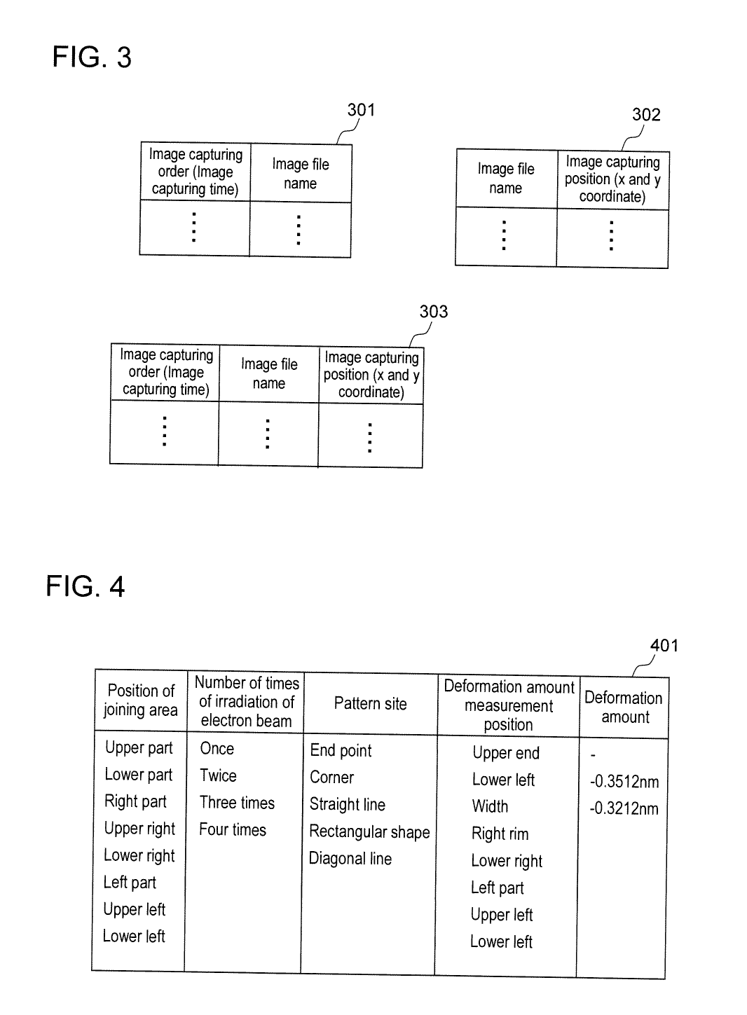

The image capturing position information storing unit 5 stores the image capturing positions of a plurality of divided images provided from the image capturing control device 12. The image capturing order information storing unit 3 stores the image capturing order of a plurality of divided images provided from the image capturing control device 12. An example of information stored in the image capturing position information storing unit 5 and image capturing order information storing unit 3 will be described with reference to FIG. 3. The deformation information storing unit 4 stores information about deformation of the resist due to irradiation of the electron beam upon image capturing. An example of deformation information stored in the deformation information storing unit 4 will be described below with reference to FIG. 4. The design data storing unit 6 stores design data which serves as the basis of a wiring pattern. That is, a wide range of pattern information including the wiring pattern of the image capturing target is stored.

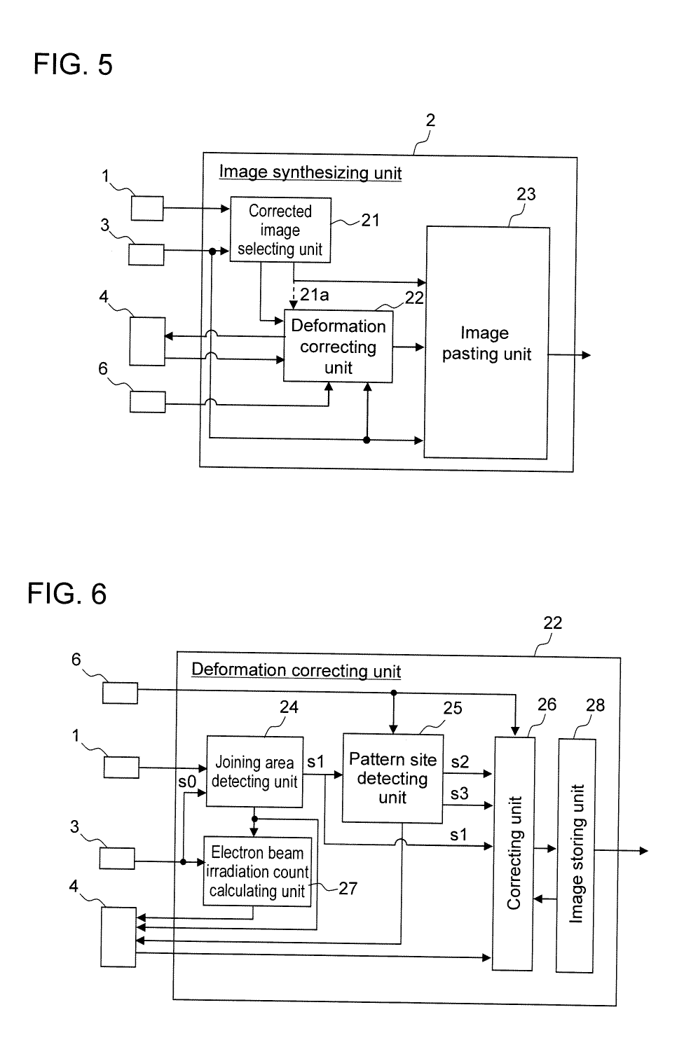

On the basis of information stored in the image capturing position information storing unit 5, image capturing order information storing unit 3, deformation information storing unit 4 and design data storing unit 6, the image synthesizing unit 2 synthesizes a plurality of items of image data stored in the image memory 1 and generates one image. The image synthesizing unit 2 further corrects the wiring patterns in joining areas of the divided images when the images are synthesized. Information of the wiring patterns corrected in this way is stored in the deformation information storing unit 4. The details of the image synthesizing unit 2 will be described with reference to FIG. 5.

The image processing unit 13 according to the present invention may be configured with a computer or computing device. Further, processing in the image processing unit 13 may be executed using software. That is, software may be executed by a computer or may be installed in a LSI and processed by hardware.

FIG. 2 illustrates a configuration of a second example of a composite image creating device according to the present invention. With this example, the image capturing position information storing unit 5 is not provided. Instead, image capturing position information is stored in the image capturing order information storing unit 3.

A configuration example of a third example of a composite image creating device according to the present invention will be described with reference to FIG. 24. The composite image creating device according to this example has the imaging device 11, image capturing control device 12 and image processing unit 13. The image processing unit 13 has the image memory 1, image capturing order information storing unit 3, deformation information storing unit 4, design data storing unit 6 and deformation information generating unit 7.

The deformation information generating unit 7 receives image capturing order information as input from the image capturing order information storing unit 3, receives image data as input from the image memory 1 and corrects wiring patterns in the joining areas of the divided images. Information of the wiring patterns corrected in this way is stored in the deformation information storing unit 4. Processing in the deformation information generating unit 7 is the same as processing of correcting the wiring patterns in the joining areas of the divided images in the image synthesizing unit 2 illustrated in FIGS. 1 and 2. Image synthesizing processing in the image synthesizing unit 2 may be, for example, the same as processing in a correcting unit illustrated in FIG. 13.

An example of data stored in the image capturing order information storing unit 3 and image capturing position information storing unit 5 illustrated in FIG. 1 will be described with reference to FIG. 3. The image capturing order information storing unit 3 stores an image capturing order information table 301. The image capturing order information table 301 can realize a memory table which stores image file names using the orders of the image capturing order as addresses. The image capturing position information storing unit 5 stores an image capturing position information table 302. The image capturing position information table 302 can be realized by a memory table which stores an image capturing position (x and y coordinates) in addresses associated with image file names.

The image capturing order information and image capturing position information table 303 includes the image capturing order, image file name and image capturing position. The image capturing order and image file name are associated one to one, so that it is possible to store image capturing order information and image capturing position information in one table 303. The image capturing order information storing unit 3 of the second example of the composite image creating device according to the present invention in FIG. 2 may store the image capturing order information and image capturing position information table 303 of this example.

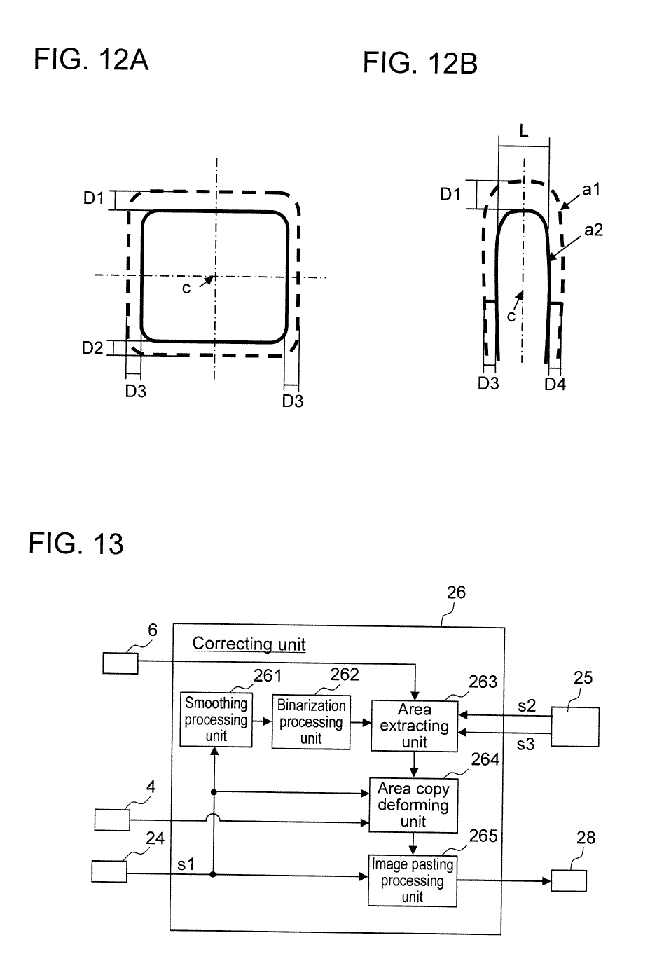

FIG. 4 illustrates an example of deformation information of a pattern stored in the deformation information storing unit 4. The deformation information storing unit 4 stores a deformation information table. The deformation information table includes, for example, a position of a joining area, the number of times of irradiation of an electron beam, a pattern site, deformation amount measurement position and pattern deformation amount. The position of the joining area indicates the position of the joining area in an image, and refers to, for example, an upper part, lower part, right part and left part. The number of times of irradiation of an electron beam represents the number of times of irradiation of an electron beam on a joining area. The pattern site represents the position of a pattern shape, and is, for example, an end point (terminal portion of a line), corner part, straight linear part, rectangular part and diagonal part. The deformation amount measurement position represents the measurement position of a pattern deformation amount, and includes, for example, a width in case of an end point. In case of the pattern, the deformation amount measurement position is, for example, an upper, lower, left and right width. The measurement position may be a distance from a reference point to a specific position of the pattern. The method of measuring the deformation amount will be described with reference to FIGS. 12A and 12B. The pattern deformation amount indicates a pattern deformation dimension, and is generally a shrinkage amount. When images are synthesized, the images are joined, that is, pasted utilizing this deformation information table.

The deformation information table illustrated in FIG. 4 includes an address of 11 bits in total including 3 bits for the joining area, 2 bits for the number of times of irradiation of an electron beam, 3 bits for a pattern site and 3 bits for the position in a pattern.

To create a deformation information table, an image of a test pattern is captured a plurality of times, and the length of each site of the test pattern images is measured per image capturing. To measure the length of each site, a point which serves as the reference is utilized as the center line of each pattern. On the basis of previous and current image capturing results, a difference value of measurement length values is acquired. This is the deformation amount. Deformation of the pattern is basically shrinkage.

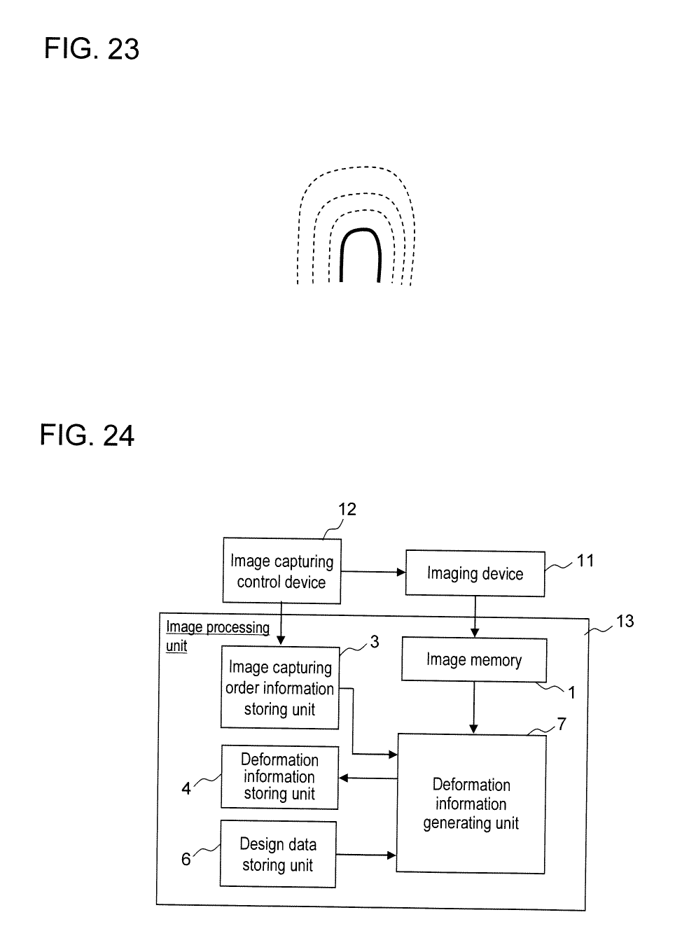

An example of pattern deformation in a joining area will be described with reference to FIG. 23. The pattern represented by an outermost dotted line is formed on an image capturing target. This joining area is irradiated with electron beam every time an image is captured. The pattern shrinks per irradiation of an electron beam, and a pattern indicated by the solid line is provided upon fourth irradiation of the electron beam. Hence, according to the present invention, a pattern image indicated by the solid line is corrected to acquire a pattern image indicated by the outermost dotted line. When the correction amount is in the order of nm, the correction amount needs to be converted into pixels. For example, a value of pixel conversion may be added to the corrected image data.

A method of calculating a deformation amount will be described with reference to FIGS. 12A and 12B. FIG. 12A illustrates a case of a pattern shape. An outline indicated by a broken line is an image before irradiation of the electron beam, and the outline indicated by the solid line is an image after irradiation of the electron beam. At upper right, lower right, upper left, and upper left corners, a difference in the distance from the reference point c is calculated before and after irradiation of the electron beam. With the example illustrated in FIG. 12A, a difference D1 on the upper side is calculated at the upper left corner, and a difference D2 on the lower side and a difference D3 on the left side are calculated at the lower left corner. A difference D3 on the right side is calculated at the lower right corner. The change of the curvatures at the upper, lower, left and right corners may be calculated.

FIG. 12B illustrates a case of an end point of a line. A line a1 indicated by a broken line is an image before irradiation of the electron beam, and a line a2 indicated by the solid line is an image after irradiation of the electron beam. A difference in the distance from the reference point c is calculated before and after irradiation of the electron beam. Although, as illustrated in FIG. 12B, the difference D1 at an end point of a line may be calculated, differences D3 and D4 of a width of a line may be calculated. In addition, when it is not clear whether an outline a2 represents a pattern or an end point of a line, this is determined by measuring a width L of the line.

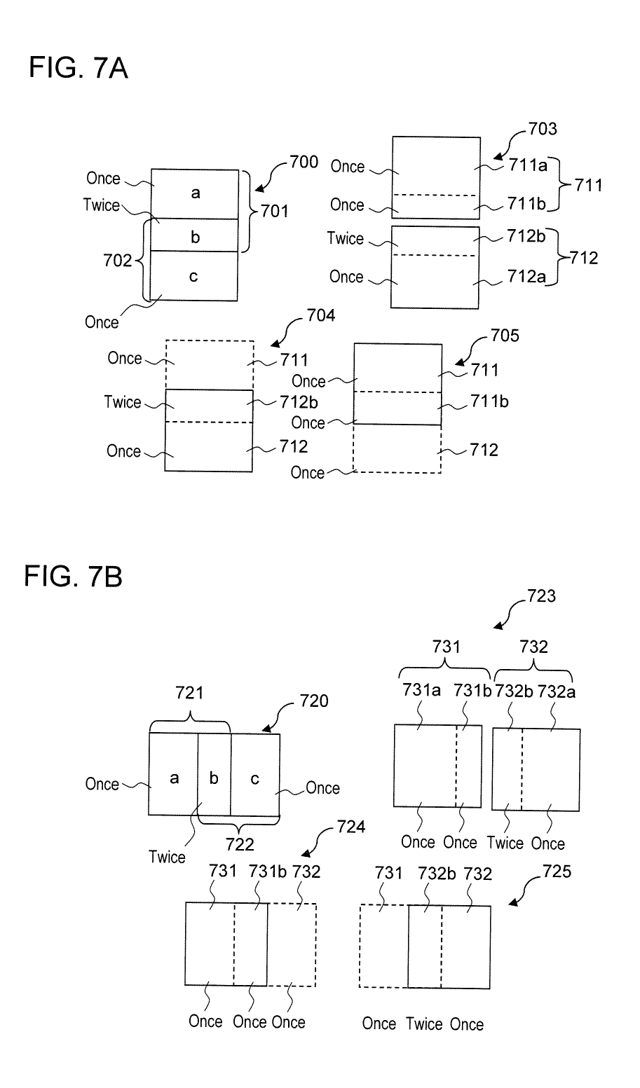

A case will be described with reference to FIGS. 7A and 7B where the composite image creating device according to the present invention joins a plurality of images to generate one panoramic image. Hereinafter, an image capturing order of images and joining order of images will be described. Two areas 701 and 702 vertically aligned are set on an area 700 on an image capturing target. The area 701 has an area “a” and an area “b”, and the area 702 has an area “b” and an area “c”. The two areas 701 and 702 overlap in the area b. The images of the areas 701 and 702 are sequentially captured in this order. When an image is captured once, an irradiation of electron beam is performed once. Although the areas “a” and “b” are irradiated with electron beam once respectively by capturing an image of the area 701, when the image of the area 702 is captured next, while the area “a” is irradiated with the second electron beam, the area “b” is irradiated with the first electron beam. There is a concern that the pattern is deformed in the area “b”.

A reference numeral 703 indicates captured images 711 and 712 of the areas 701 and 702. The image 711 includes a non joining area 711a and a joining area 711b, and the image 712 includes a non-joining area 712a and a joining area 712b. The joining area 712b of the image 712 is an image portion corresponding to the area b, and therefore is an image obtained upon second irradiation of the electron beam. Hence, there is a concern that, from the joining area 712b of the image 712, an image of the deformed pattern is obtained.

The two images 711 and 712 are joined to generate panoramic images 704 and 705. The panoramic image 704 is synthesized by joining the subsequently captured image 712 overlapping on the previously captured image 711. In this case, in a pasting area of the two images, the joining area 711b is removed and the joining area 712b is left. Hence, the panoramic image 704 includes the joining area 712b of the subsequently captured image 712. Therefore, it is necessary to correct the pattern in the joining area 712b of the image 712 upon joining.

The panoramic image 705 is synthesized by joining the previously captured image 711 overlapping on the subsequently captured image 712. In this case, in an overlapping area of the two images, the joining area 711b is left and the joining area 712b is removed. Hence, the panoramic image 705 includes the joining area 711b of the previously captured image 711. The panoramic image 705 includes images all of which are obtained by irradiation of the electron beam once. Therefore, it is not necessary to correct the pattern in the joining area of the two images upon joining.

With the example illustrated in FIG. 7B, two areas 721 and 722 aligned horizontally are set in the area 720 on the image capturing target. The area 721 has an area “a” and an area “b”, and the area 722 has an area b and an area c. The two areas 721 and 722 overlap in the area “b”. The two areas 721 and 722 are sequentially captured. A reference numeral 723 indicates images 731 and 732 capturing the areas 721 and 722, respectively.

The two images 731 and 732 are joined to generate panoramic images 724 and 725. The panoramic image 724 is synthesized by joining the previously captured image 731 overlapping on the subsequently captured image 732. In this case, in an overlapping area of the two images, the joining area 731b is left and the joining area 732b is removed. Hence, the panoramic image 724 includes the joining area 731b of the previously captured image 731. The panoramic image 724 includes images all of which are obtained by irradiation of electron beam once. Therefore, it is not necessary to correct the pattern in the joining area of the two images upon joining. The panoramic image 725 is synthesized by joining the subsequently captured image 732 overlapping on the previously captured image 731. In this case, in an overlapping area of the two images, the joining area 731b is removed and the joining area 732b is left. Hence, the panoramic image 725 includes the joining area 732b of the subsequently captured image 732. Therefore, it is necessary to correct the pattern in the joining area 732b of the image 732 upon joining.

As described above, when two images are joined to generate a panoramic image, correction of a pattern in a joining area can be avoided by overlapping an image of an earlier image capturing order on an image of a later image capturing order and leaving the joining area of an image of an earlier image capturing order.

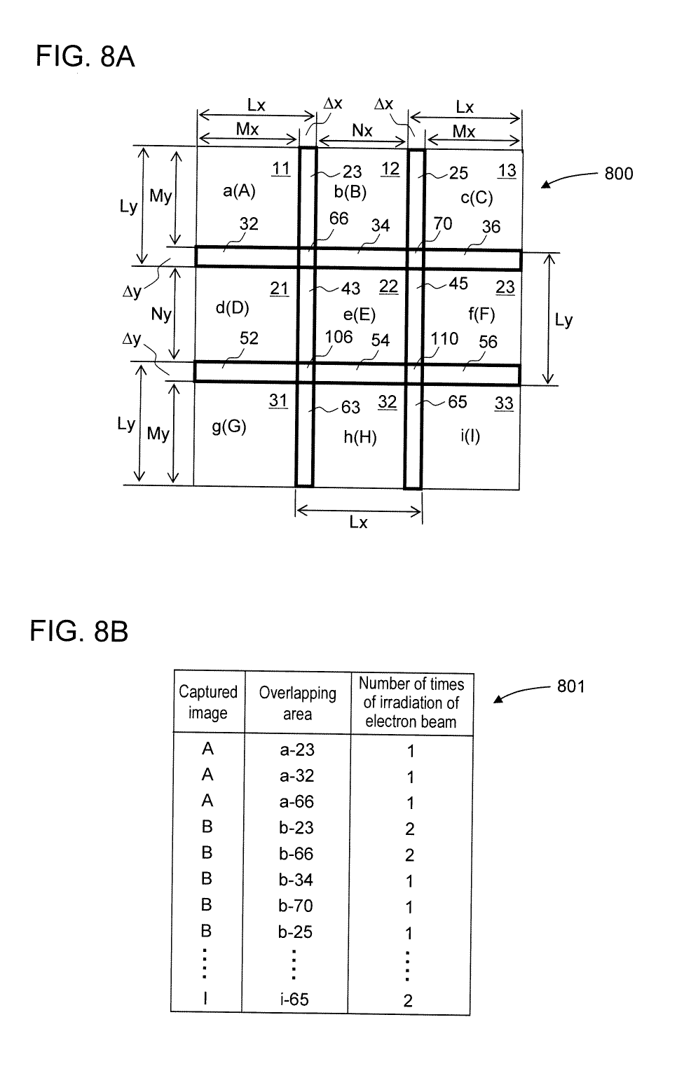

The relationship of the image capturing order and the number of times of irradiation of an electron beam in the joining area will be described with reference to FIGS. 8A and 8B. Nine areas “a” to “i” are set on an image capturing target 800. The dimensions of all areas “a” to “i” are the same, and the horizontal dimensions is Lx and the vertical dimension is Ly. The two adjacent areas have overlapping areas respectively. That is, each area has a non-overlapping area and overlapping areas. The width of the overlapping area of the two horizontally adjacent areas is Δx, and the width of the two vertically adjacent areas is Δy. The horizontal dimension of an image capturing target is 3Lx−2Δx, and the vertical dimension is 3Ly−2Δy.

One image is generated by radiating an electron beam once. The images of nine areas “a” to “i” are captured in an alphabetical order to obtain nine images A to I. When the nine images A to I are generated in this way, irradiation of electron beam is performed once in non-overlapping areas 11, 12, 13, 21, 22, 23, 31, 32 and 33 in each of the areas a to i. However, irradiation of electron beam is performed twice on the overlapping areas 23, 25, 43, 45, 63, 65, 32, 34, 36, 52, 54 and 56. The irradiation of electron beam is performed four times on the overlapping areas 66, 70, 106 and 110.

In addition, the horizontal dimension of the non-overlapping area 11 of the upper left area a is Mx=Lx−Δx, and the vertical dimension is My=Ly−Δy. The horizontal dimension of the non-overlapping area 12 of the upper center area B is Nx=Lx−2Δx, and the vertical dimension is My=Ly−Δy. The horizontal dimension of the non-overlapping area 22 of the center area E is Nx=Lx−2Δx, and the vertical dimension is Ny=Ly−2Δy.

Of the upper left area a of the overlapping areas, the length of the overlapping area 32 extending in the horizontal direction is Mx, and the length of the overlapping area 23 extending in the vertical direction is My. Of the center overlapping area E, the lengths of the overlapping areas 34 and 54 extending in the horizontal direction is Nx, and the lengths of the overlapping areas 43 and 45 extending in the vertical direction is Ny. The horizontal dimensions of the four overlapping areas 66, 70, 106 and 110 are Δx, and the vertical dimensions are Δy.

A table 801 in FIG. 8B illustrates the number of times of irradiation of an electron beam on the overlapping areas in each of the areas “a” to “i” when the nine images A to I are generated in an alphabetical order. This table 801 illustrates the relationship between a captured image, overlapping area and the number of times of irradiation of an electron beam. First, the area “a” is first irradiated with an electron beam to generate the image A. The number of times of irradiation of the electron beam on the overlapping areas 23, 32 and 66 is one. Next, the area “b” is irradiated with the electron beam to generate the image B. The number of times of irradiation of the electron beam on the overlapping areas 23 and 66 is two. However, the number of times of irradiation of the electron beam on the overlapping areas 34, 70 and 25 is one.

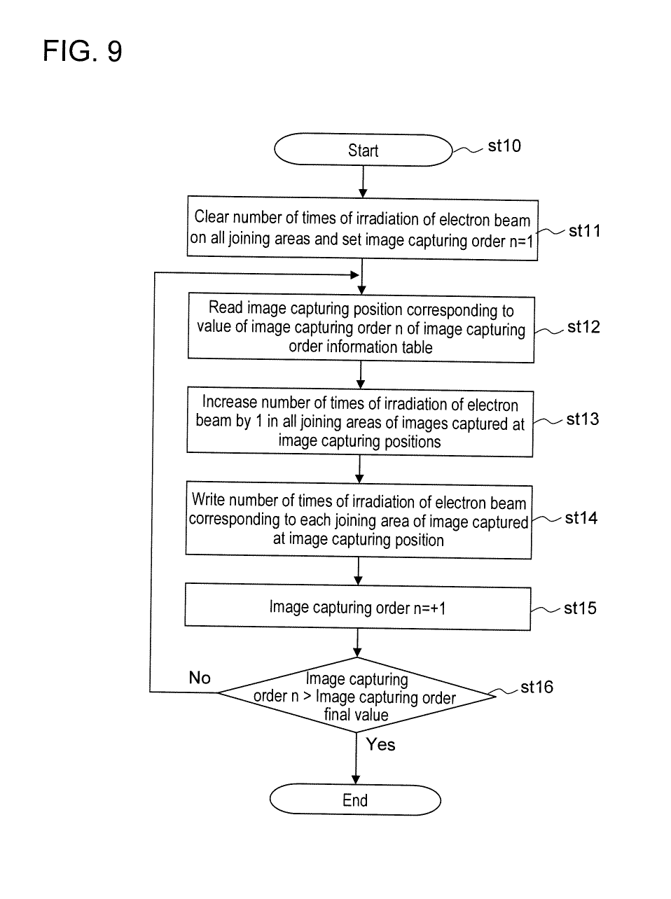

Processing of calculating the number of times of irradiation of the electron beam in each overlapping area in the composite image creating device according to the present invention will be described with reference to FIG. 9. That is, the table showing the number of times of irradiation of an electron beam in each overlapping area illustrated in FIG. 8B is created. With this example, the image capturing order information table 303 illustrated in FIG. 3 is given in advance. That is, the image capturing order and image capturing position are set in advance for all images. Hereinafter, as illustrated in FIG. 8A, the images of the areas “a” to “i” are captured in an alphabetical order to obtain nine images. The positions of the areas “a” to “i” are given in advance. For example, the areas “a” to “i” are aligned from the smallest order of the X coordinate and Y coordinate. Thus, when the areas “a” to “i” are aligned, the images A to I are sequentially assigned.

In step S11, the index representing the number of times of irradiation in all joining areas is k=0, and the index representing the image capturing order is n=1. With the example in FIG. 8A, there are sixteen overlapping areas 23, 25, 43, 45, 63, 65, 32, 34, 36, 52, 54, 56, 66, 70, 106 and 110 for the nine areas “a” to “i”. A memory area which stores the number of times of irradiation of the electron beam is provided for each overlapping area, and is cleared. To a counter value n corresponding to the image capturing order, 1 is set.

In step S12, the image capturing position corresponding to the image capturing order n of the image capturing order information table is read. At the current point of time, n=1 and therefore the image capturing position of an image of the first image capturing order is read. By referring to the image capturing order information table 303 illustrated in FIG. 3, which image of the nine images A to I the image of the first image capturing order is decided. With this example, images are captured in an alphabetical order, and the image in the first image capturing order is the image A.

In step S13, 1 is added as the number of times of irradiation of the electron beam, to memory areas corresponding to all overlapping areas included in areas corresponding to the nth image capturing order in the image capturing order information table. With this example, 1 is added as the number of times of irradiation of the electron beam, to memory areas corresponding to the overlapping areas 23, 32 and 66 included in the area a.

In step S14, 1 is stored in the column of the number of times of irradiation of the electron beam corresponding to the overlapping areas 23, 32 and 66 included in the area a of the table in FIG. 8(b).

In step S15, the index representing the image capturing order is increased by 1. That is, n=n+1. In step S16, whether or not the image capturing order n is greater than an image capturing order final value is decided. With this example, nine images are generated, and therefore the image capturing order final value is 9. When the image capturing order n is greater than the image capturing order final value, processing is finished, and, when the image capturing order n is equal to or less than the image capturing order final value, the step returns to step S12 and processings of step S12 to step S15 are repeated. Thus, when processing of step S15 is finished, the table illustrated in FIG. 8B is generated.

An example of the image synthesizing unit 2 according to the present invention will be described with reference to FIG. 5. The image synthesizing unit 2 of this example has a corrected image selecting unit 21, a deformation correcting unit 22 and an image pasting unit 23. The corrected image selecting unit 21 receives the image capturing order as input from the image capturing order information storing unit 3, and reads two images from the image memory 1. The corrected image selecting unit 21 outputs one of the two images of the later image capturing order to the deformation correcting unit 22, and outputs the image of the earlier image capturing order, to the image pasting unit 23. With this example, the image of the later image capturing order is corrected, and the image of the earlier image capturing order is not corrected.

The corrected image selecting unit 21 may have selectors which are switched on the basis of the image capturing order. That is, two selectors are provided, and one of the selectors selects the image of the later image capturing order to output to the deformation correcting unit 22, and the other selector selects the image of the earlier image capturing order to output to the image pasting unit 23.

The deformation correcting unit 22 receives the image capturing order as input from the image capturing order information storing unit 3, receives information about deformation of a resist due to irradiation of the electron beam as input from the deformation information storing unit 4 and receives design data as input from the design data storing unit 6. Using these pieces of information, the deformation correcting unit 22 corrects the wiring pattern in the joining area of the image of the later image capturing order from the corrected image selecting unit 21. As described referring to FIG. 7, when images of adjacent areas on the image capturing target are sequentially captured, the subsequently captured image includes an image portion which is obtained with multiple irradiation of electron beam. Hence, the deformation correcting unit 22 according to the present embodiment corrects the image of the joining area for the image of the later image capturing order. The deformation correcting unit 22 outputs this corrected image to the image pasting unit 23, and simultaneously feeds back this corrected image to the deformation information storing unit 4 as a template image.

The image pasting unit 23 receives the image of the later image capturing order as input from the corrected image selecting unit 21, receives the corrected image of the image of the later image capturing order from the deformation correcting unit 22 and further receives the image capturing order from the image capturing order information storing unit 3. The image pasting unit 23 performs matching processing of images of joining areas for the two images, and detects joining positions to synthesize the images. The details of processing in the image pasting unit 23 will be described below with reference to FIG. 19.

The deformation correcting unit 22 according to this example may correct the image of the later image capturing order such that the number of times of irradiation of the electron beam is the same in the joining areas of the two images. This correction is performed by calculating the difference in the number of times of irradiation of an electron beam in the joining areas between the image of the earlier image capturing order and the image of the later image capturing order. On the basis of the deformation amount corresponding to this difference, the image of the joining area may be corrected.

Although the deformation correcting unit 22 according to this example corrects the image of the later image capturing order, the deformation correcting unit 22 may correct an image 21a of the earlier image capturing order, too. That is, the pattern is corrected such that the number of times of irradiation of the electron beam is the same in the joining areas for both of the image of the earlier image capturing order and the image of the later image capturing order. For example, the pattern may be deformed such that the number of times of irradiation of the electron beam is one in the joining areas of the two images.

An example of the deformation correcting unit 22 of the image synthesizing unit 2 according to the present invention will be described with reference to FIG. 6. The deformation correcting unit 22 has a joining area detecting unit 24, a pattern site detecting unit 25, a correcting unit 26, an image capturing count calculating unit 27 and an image storing unit 28.

The joining area detecting unit 24 receives an image as input from the image memory 1, receives an image capturing order s0 from the image capturing order information storing unit 3 and detects joining areas in an image. The joining areas are image portions of areas which are likely to be irradiated with the electron beam a plurality of times. The joining area detecting unit 24 outputs image data s1 of the joining area to the pattern site detecting unit 25, correcting unit 26 and electron beam irradiation count calculating unit 27.

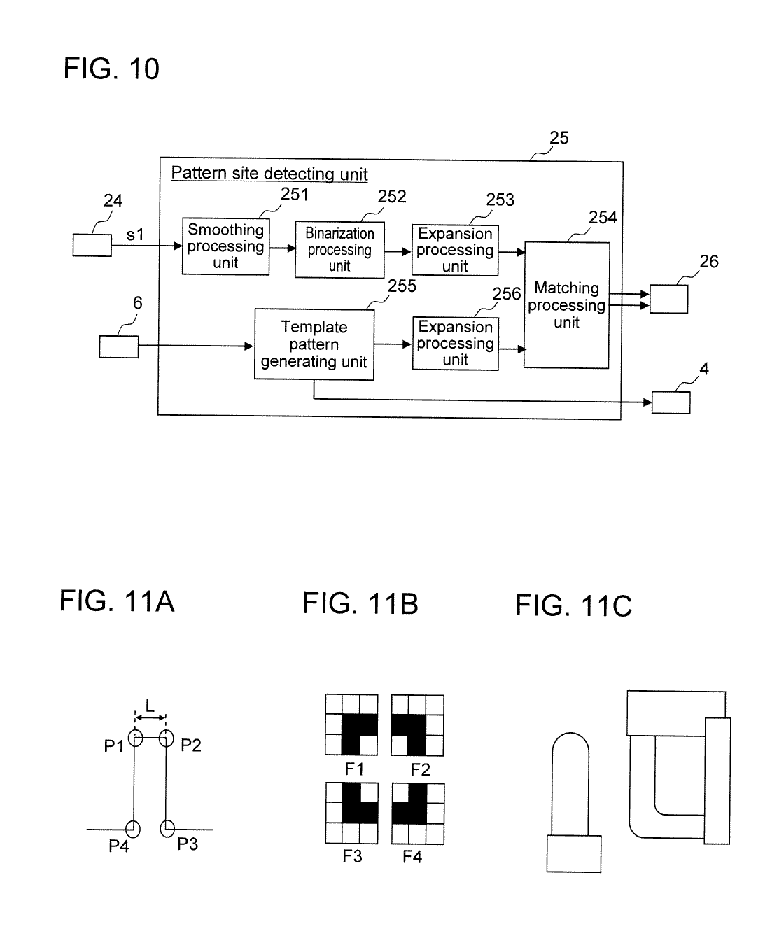

The pattern site detecting unit 25 receives image data s1 of the joining area as input from the joining area detecting unit 24, and receives design data from the design data storing unit 6. The pattern site detecting unit 25 detects a pattern site s2 and deformation amount measurement position s3 from image data s1 of the joining area, and outputs these to the correcting unit 26. The pattern site s2 and deformation amount measurement position s3 have been described with reference to FIG. 4. That is, the pattern site s2 is, for example, an end point, corner part, straight linear, rectangular shape or diagonal line. The deformation amount measurement position s3 varies depending on the type of the pattern site s2, and is, for example, the width or distance between the reference position and upper end when, for example, the pattern site is an end point. The pattern site detecting unit 25 will be described in detail with reference to FIGS. 10 and 11.

The correcting unit 26 receives as input the image data s1 of the joining area from the joining area detecting unit 24, the pattern site s2 and deformation amount measurement position s3 from the pattern site detecting unit 25, the deformation amount from the deformation information storing unit 4 and design data from the design data storing unit 6, and corrects the image data of the joining area to store in the image storing unit 28. The details of correction processing in the correcting unit 26 will be described with reference to FIG. 13.

When there are a plurality of patterns in a joining area, this correction processing only needs to be repeated per pattern. With the second or subsequent correction processing, image data after correction processing may be read from the image storing unit 28 to overwrite only the corrected pattern site or paste the corrected pattern site on existing image data.

The electron beam irradiation count calculating unit 27 receives the image data s1 of a joining area as input from the joining area detecting unit 24, receives the image capturing order as input from the image capturing order information storing unit 3 and calculates the number of times of irradiation of the electron beam on each joining area. The electron beam irradiation count calculating unit 27 stores the number of times of irradiation of the electron beam in each joining area, in the table of the deformation information storing unit 4.

An example of the pattern site detecting unit 25 of the deformation correcting unit 22 of the image synthesizing unit 2 according to the present invention will be described with reference to FIG. 10. The pattern site detecting unit 25 according to this example has a smoothing processing unit 251, a binarization processing unit 252, two expansion processing units 253 and 256, a matching processing unit 254 and a template pattern generating unit 255. The smoothing processing unit 251 receives image data s1 of a joining area as input from the joining area detecting unit 24, and smoothes the image data s1. The binarization processing unit 252 binarizes image data s1 of a joining area from the smoothing processing unit 251 to output to the expansion processing unit 253. The expansion processing unit 253 expands the binarized data from the binarization processing unit 252 by expansion processing.

By contrast with this, the template pattern generating unit 255 reads design data corresponding to the joining area from the design data storing unit 6, and creates a template image from the pattern in the joining area. The template pattern generating unit 255 outputs the template image to the deformation information storing unit 4 and expansion processing unit 256. The expansion processing unit 256 expands the template image by expansion processing.

The matching processing unit 254 matches the binarized and expanded data obtained from the image data s1 of the joining area, and expanded data of the template image to detect the pattern site. The matching processing unit 254 outputs the pattern site s2 and deformation amount measurement position s3 to the correcting unit 26.

The matching processing unit 254 may use a matching which uses normalization correlation processing. However, the matching processing unit 254 according to this example matches binarized images. Hence, by simply finding the matching number of black pixels and white pixels and comparing the number with a predetermined threshold, whether or not a pattern is the same as the pattern of the template image may be decided.

The smoothing processing unit 251 according to this example may smooth input data using a Gaussian filter. The binarization processing unit 252 may binarize input data by common binarization processing. That is, a pixel value greater than the threshold is 1, and a pixel value smaller than the threshold is 0. The expansion processing units 253 and 256 may binarize input data by common expansion processing. For example, when the number of black pixels is one, all eight pixels adjacent around this black pixel are made black. By repeating this processing, the pattern is expanded.

An example of a method of generating a template pattern in the template pattern generating unit 255 will be described with reference to FIGS. 11A, 11B, and 11C. As long as an image capturing position of a captured image and the position of a joining area on the captured image, that is, upper, lower, left or right portion of the captured image are learned, it is possible to find a coordinate range on design data in the joining area of the captured image. Design data including this coordinate range is converted into binary image data, and a corner is detected using a corner detecting filter.

FIG. 11A illustrates an example of a pattern of design data corresponding to a joining area. The pattern according to the present embodiment includes a belt shape projection having the width L. The pattern according to this example includes two end points (line ends) P1 and P2, two corner parts P3 and P4 and a linear part between the adjacent end points. FIG. 11B illustrates an example of the corner detecting filter. By using filters F1 to F4, it is possible to detect end points P1 and P2 and corner parts P3 and P4. For example, if the outline of the pattern site including the end point P1 of design data matches with a filter F1, it is decided that there is a corner having a shape corresponding to the filter F1. Thus, the outline of the detected pattern site is used as a template image. In addition, the template pattern is generated on the basis of design data and therefore includes a right-angled shape as illustrated in FIG. 11A. However, captured images of end points and corner parts are not actually right-angled. Therefore, when the end points or corner parts are detected, as illustrated in FIG. 11C, a template pattern may be replaced with a pattern interpolated to an outline shape similar to an actual pattern.

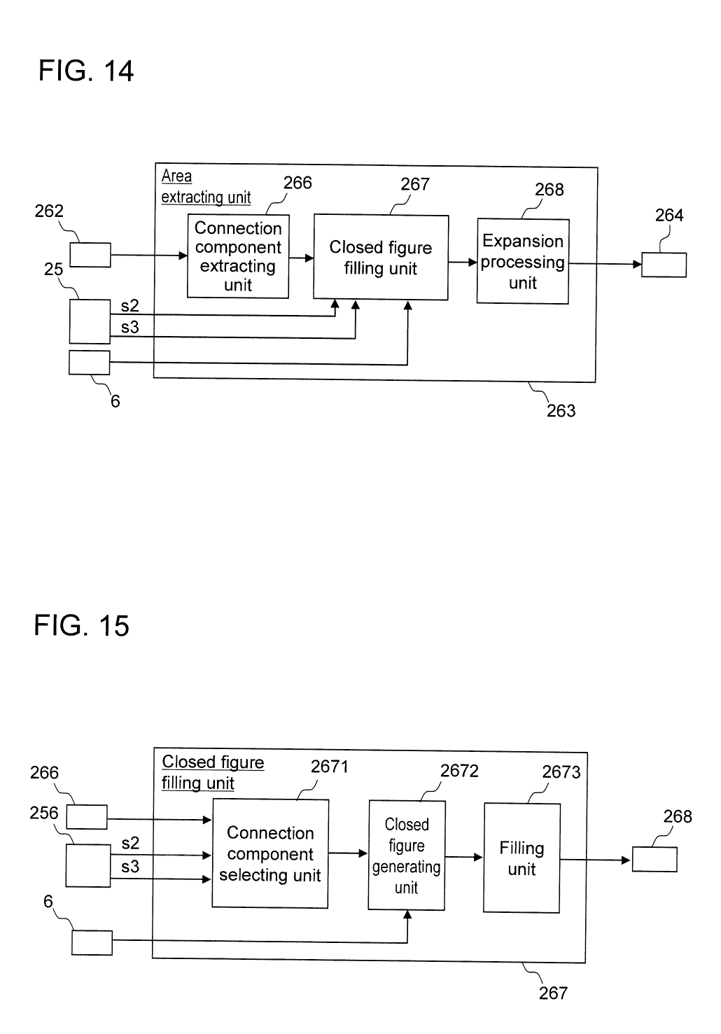

An example of the correcting unit 26 of the deformation correcting unit 22 of the image synthesizing unit 2 according to the present invention will be described with reference to FIG. 13. The correcting unit 26 has a smoothing processing unit 261, a binarization processing unit 262, an area extracting unit 263, an area copy deforming unit 264 and an image pasting processing unit 265. The smoothing processing unit 261 receives image data s1 of the joining area as input from the joining area detecting unit 24, and smoothes the image data s1. The binarization processing unit 262 binarizes image data s1 of the joining area from the smoothing processing unit 261 to output to the area extracting unit 263. The area extracting unit 263 receives as input binarized data from the binarization processing unit 262, design data from the design data storing unit 6, pattern site s2 and deformation amount measurement position s3 from the pattern site detecting unit 25. The area extracting unit 263 extracts a pattern area, and outputs image data of the pattern area to the area copy deforming unit 264. The details of the area extracting unit 263 will be described with reference to FIG. 14.

The area copy deforming unit 264 receives as input image data of the pattern area from the area extracting unit 263, information about deformation of the resist due to irradiation of the electron from the deformation information storing unit 4 and image data s1 of the joining area from the joining area detecting unit 24, and copies and corrects a pattern image. The details of the area copy deforming unit 264 will be described with reference to FIG. 17. The area copy deforming unit 264 outputs the corrected pattern image to the image pasting processing unit 265. The image pasting processing unit 265 receives as input image data s1 of the joining area from the joining area detecting unit 24 and a corrected pattern image from the area copy deforming unit 264, and pastes the corrected pattern image on the image data s1 of the joining area.

An example of the area extracting unit 263 of the correcting unit 26 of the deformation correcting unit 22 of the image synthesizing unit 2 according to the present invention will be described with reference to FIG. 14. The area extracting unit 263 has a connection component extracting unit 266, a closed figure filling unit 267 and an expansion processing unit 268. The connection component extracting unit 266 receives as input binarized data of the image data s1 of the joining area from the binarization processing unit 262, and extracts a connection component of the black pixel. The connection component extracting unit 266 extracts the connection component using a generally known 8-connection method.

The closed figure filling unit 267 receives as input the connection component of the black pixel from the connection component extracting unit 266, design data from the design data storing unit 6 and the pattern site s2 and deformation amount measurement position s3 from the pattern site detecting unit 25, creates a closed figure and fill inside the closed figure. The expansion processing unit 268 expands the filled closed figure. Expansion processing in the expansion processing unit 268 may be the same as the expansion processing in the expansion processing units 253 and 256 of the pattern site detecting unit 25 which has been described with reference to FIG. 10. The rim portion of the pattern which is binarized and found fluctuates due to the threshold. Therefore, there is a concern that the rim of the original pattern does not fit in the closed figure completely. Hence, by performing expansion processing of the closed figure, a margin is provided such that the rim of the pattern reliably fits in the closed figure.

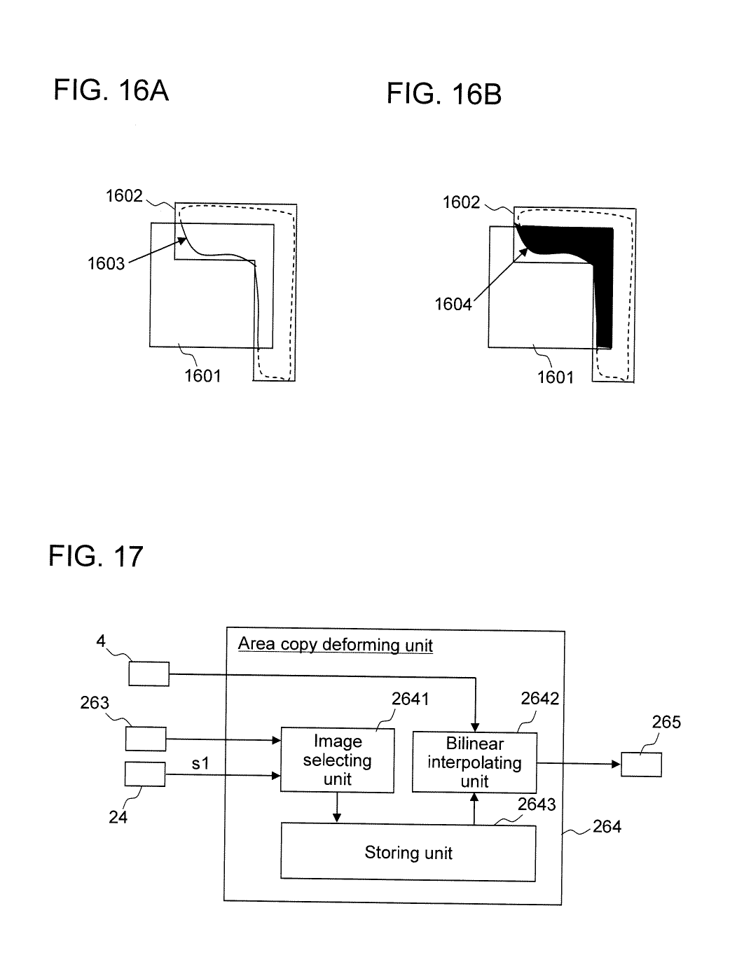

An example of the closed figure filling unit 267 of the area extracting unit 263 of the correcting unit 26 of the deformation correcting unit 22 of the image synthesizing unit 2 according to the present invention will be described with reference to FIGS. 15, 16A and 16B. The closed figure filling unit 267 has a connection component selecting unit 2671, a closed figure generating unit 2672 and a filling unit 2673.

The connection component selecting unit 2671 receives as input the connection component of the black pixel of binarized data of image data s1 of the joining area from the connection component extracting unit 266, and the pattern site s2 and deformation amount measurement position s3 from the pattern site detecting unit 25. The connection component selecting unit 2671 selects a connection component including a correction target pattern 1601 among connection components received as input from the connection component extracting unit 266, for example, as follows. The connection component selecting unit 2671 first finds the distance between each pixel of a connection component 1603 and a pixel position at which the correction target pattern 1601 exists. On the basis of this distance, a connection component 1604 including a pixel closest to the pixel position at which the corrected target pattern 1601 exists is selected in the connection component 1603.

The closed figure generating unit 2672 generates a closed figure formed with a connection component including the correction target pattern in the connection component selected by the connection component selecting unit 2671. FIG. 16A illustrates a case where the connection component 1603 received as input from the connection component extracting unit 266 is a pattern of a corner. As illustrated in FIG. 16B, the connection component 1603 can be classified into two consisting of a portion inside the corrected target pattern 1601 and a portion outside the corrected target pattern 1601. Design data 1602 of the connection component 1603 is obtained from the design data storing unit 6. The closed figure generating unit 2672 selects the portion inside the corrected target pattern 1601 among these two areas using design data 1602 corresponding to the connection component 1603. The portion inside the corrected target pattern 1601 selected in this way is one closed figure.

The filling unit 2673 fills the closed figure with black. Thus, as illustrated in FIG. 16B, the closed FIG. 1604 filled with black is obtained.

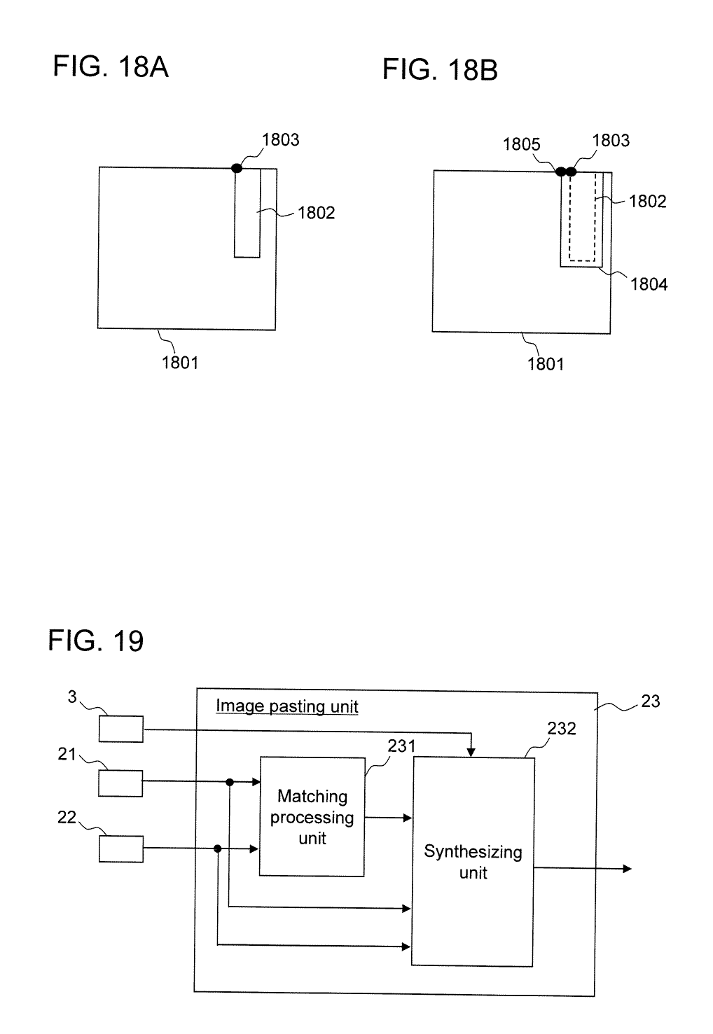

An example of the area copy deforming unit 264 of the correcting unit 26 of the deformation correcting unit 22 of the image synthesizing unit 2 according to the present invention will be described with reference to FIGS. 17, 18A and 18B. The area copy deforming unit 264 has an image selecting unit 2641, a bilinear interpolating unit 2642 and a storing unit 2643. The image selecting unit 2641 receives as input image data of the pattern area from the area extracting unit 263 and image data s1 of the joining area from the joining area detecting unit 24, and selects the image data s1 of the joining area corresponding to the pattern area to store in the storing unit 2643.

Image data of the pattern area received as input from the area extracting unit 263 is a closed figure filled with black as illustrated in FIG. 16. For example, the image selecting unit 2641 assigns “1” to the pixel of the closed figure filled with black and “0” to a pixel of a portion which is not filled with black. A value obtained by multiplying a value of this pixel with the coordinate of the pixel may be stored in the storing unit 2643.

The bilinear interpolating unit 2642 receives image data s1 of the joining area corresponding to the pattern area as input from the storing unit 2643, and receives resist deformation information as input from the deformation information storing unit 4. The bilinear interpolating unit 2642 corrects, that is, expands image data s1 of the joining area by bilinear interpolation using deformation information.

Bilinear interpolation processing in the bilinear interpolating unit 2642 will be described with reference to FIGS. 18A and 18B. FIG. 18A illustrates an example of image data s1 of a joining area 1801, that is, a closed figure pattern 1802 received as input from the area extracting unit 263. The width of this pattern 1802 is 147 pixels from the 53th pixel to the 200th pixel in the x direction in an mth line. According to deformation information from the deformation information storing unit 4, the deformation amount of the pattern 1802 in this joining area 1801 is −3 nm on the left side and −2 nm on the right side. Conversion is performed on the basis of 1 nm=1 pixel. In this case, the pattern 1802 is expanded by three pixels on the left side, and expanded by two pixels on the right side. As a result, the width of this pattern 1804 is 152 pixels from the 50th pixel to the 202th pixel in the x direction in an mth line. Further, a point 1803 moves three pixels to the left side and becomes a point 1805. FIG. 18B illustrates a pattern 1804 expanded by bilinear interpolation processing. A case has been described here where deformation information from the deformation information storing unit 4 is the expansion amount in the X direction. The same applies when deformation information is the expansion amount in the X direction.

FIG. 19 illustrates an example of the image pasting unit 23 of the image synthesizing unit 2 according to the present invention. The image pasting unit 23 has a matching processing unit 231 and synthesizing unit 232. The match processing unit 231 receives the image of the later image capturing order as input from the corrected image selecting unit 21, and receives a deformed image of the image of the later image capturing order as input from the deformation correcting unit 22. As described with reference to FIG. 5, although the image synthesizing unit 2 basically deforms the image of the joining area of the image of the later image capturing order, the image synthesizing unit 2 does not deform the image of the earlier image capturing order. Hence, using the image of the later image capturing order, that is, the image for which deformation is corrected as a template, the matching processing unit 231 according to the present embodiment detects the position of the image of the joining area of the image of the earlier image capturing order. With the present embodiment, the deformation correcting unit 22 performs positioning using as a template the image for which deformation is corrected, so that it is possible to perform precise matching.

The synthesizing unit 232 receives as input position information from the matching processing unit 231, the image of the later image capturing order from the corrected image selecting unit 21, the image of the later image capturing order from the deformation correcting unit 22 and the image capturing order from the image capturing order information storing unit 3. The synthesizing unit 232 joins and synthesizes two images on the basis of position information detected in the matching processing unit 231.

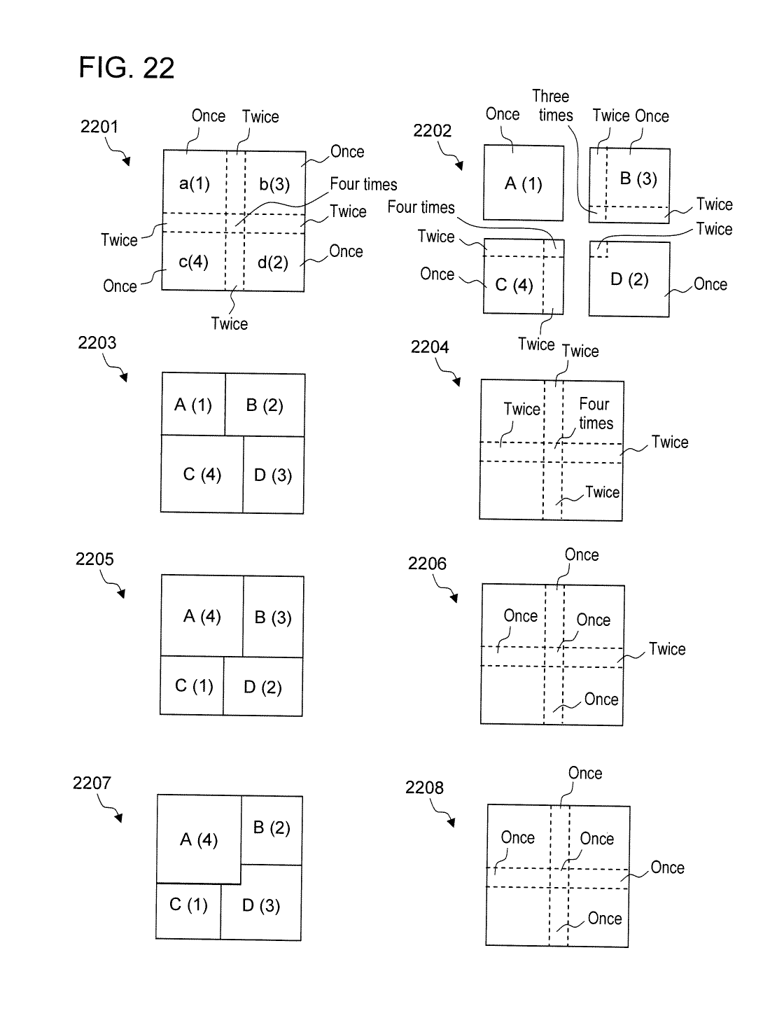

A method of joining processing in the image pasting unit 23 of the image synthesizing unit 2 according to the present invention will be described with reference to FIG. 22. Four areas “a” to “d” are set for an image capturing target 2201. The dimensions of all areas “a” to “d” are the same. The overlapping areas indicated by broken lines are provided in adjacent areas as illustrated in FIG. 22. First, the image capturing order will be described. When images are captured in an alphabetical order, the image of the area “a” is captured and then the image of the area b is captured. Hence, the overlapping area of the area “a” and area “b” is irradiated with the first electron beam, and then, after a short time, with the second electron beam. By contrast with this, a case will be explained where at first an image of the area “a” is captured, further an image of the area d is captured and, then, images of the areas b and c are captured in this order. The overlapping area of the area “a” and area “b” is irradiated with the first electron beam and, then, after a relatively long time, with the second electron beam. Hence, it is more preferable to select areas which are not adjacent to each other and capture images of such areas rather than to capture images in an alphabetical order, that is, images of adjacent areas sequentially.

Here, images of the area a, area d, area b and area c are captured in this order. The numbers added to alphabets represent the image capturing order. After images of all areas are captured, the number of times of irradiation of the electron beam is two in a long and thin overlapping area, and the number of times of irradiation of the electron beam is four in the center square overlapping area.

Four images 2202 are obtained by sequentially capturing images of the area a, area d, area b and area c. The numbers added to alphabets represent the image capturing order. As illustrated in FIG. 22, in case of the image A, images with irradiation of electron beam once are obtained in all areas. In case of the image D, although an image with irradiation of electron beam twice is obtained in the square joining area indicated by the broken line, an image with irradiation of electron beam once is obtained in the other area. In case of the image B, images with irradiation of electron beam twice are obtained in long and thin joining areas, an image with irradiation of electron beam three times is obtained in the square joining area, and an image with irradiation of electron beam once is obtained in the other area. In case of the image C, images with irradiation of electron beam twice are obtained in long and thin joining areas, an image with irradiation of electron beam three times is obtained in the square joining area, and an image with irradiation of electron beam once is obtained in the other area.

Next, the joining order will be described. As described above, generally for an earlier image capturing order, an image with less irradiation of electron beam can be obtained. As described above, when two images are joined, the lower joining area is removed and upper joining area is left in the joining areas to be overlapped. A panoramic image can include the images of areas which are obtained with less irradiation of electron beam by arranging the image of the later image capturing order on the lower side, arranging the image of the earlier image capturing order on the upper side and leaving the joining area of the image of the earlier image capturing order in the joining area.

The panoramic image 2203 is obtained by overlapping and synthesizing the joining areas of the image A, image B, image D and image C in this order. The numbers added to alphabets represent the overlapping order. The panoramic image 2204 represents the number of times of irradiation of the electron beam in each joining area of the panoramic image 2203. Images with irradiation of electron beam twice are obtained in long and thin joining areas, an image with irradiation of electron beam four times is obtained in a square joining area, and an image with irradiation of electron beam once is obtained in the other areas.

The panoramic image 2205 is obtained by overlapping and synthesizing the joining areas of the image C, image D, image B and image A in this order. The numbers added to alphabets represent the overlapping order. The panoramic image 2206 represents the number of times of irradiation of the electron beam in each joining area of the panoramic image 2205. In the long and thin joining area between the image B and image D, images with irradiation of electron beam twice are obtained, and, in the other area, an image with irradiation of electron beam once is obtained.

The panoramic image 2207 is obtained by overlapping and synthesizing the joining areas of the image C, image B, image D and image A in this order. The numbers added to alphabets represent the overlapping order. The panoramic image 2208 represents the number of times of irradiation of the electron beam in each joining area of the panoramic image 2207. Images with irradiation of electron beam once are obtained in all areas. The overlapping order of four images in the panoramic image 2207 is just opposite to the image capturing order in the four areas a to d in the image capturing target 2201 upon comparison. That is, images only need to be joined according to the order opposite to the image capturing order.

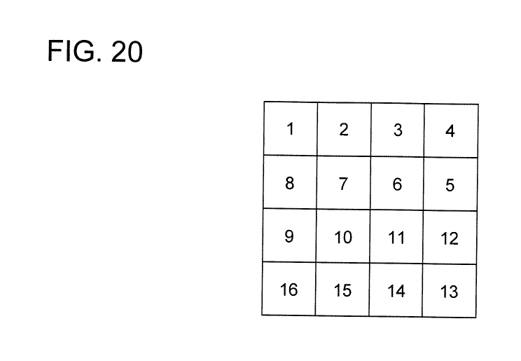

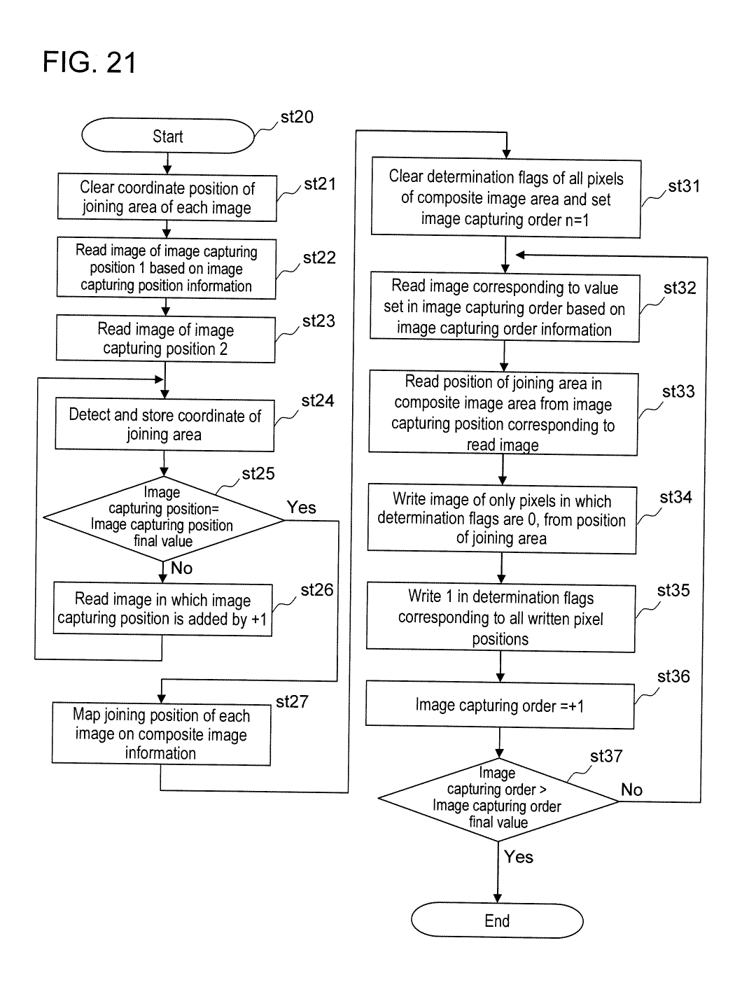

Joining processing according to the present invention will be described with reference to FIGS. 20 and 21. As illustrated in FIG. 20, sixteen areas 1 to 16 of four horizontal areas and four vertical areas in total are set on the image capturing target, and images 1 to 16 obtained by capturing these images are joined to generate one panoramic image. According to the image capturing order, the images of the adjacent areas are not continuously captured. If the overlapping area of the adjacent areas is continuously irradiated with the electron beam in a short time, there are cases where the overlapping area is charged, the image is distorted and the pattern cannot be seen.

According to the joining process of the present embodiment, coordinates of all joining areas will be first calculated on the basis of the position coordinates of an area. Next, all images are pasted on the basis of the image capturing order.

In step S21, the joining position coordinate of each image is initialized, in step S22, the first image of the images 1 to 16 corresponding to the areas 1 to 16 is read, in step S23, the second image 2 is read and, in step S24, positions of the joining areas of the first image 1 and second image 2 are calculated and the coordinates are stored.

In step S25, whether or not the current image is the final image, and, if the image is not final, an image of one subsequent order is read. Step S25 and step S26 are repeated in this way to find the position of the joining area of the final image.

In step S27, joining coordinates of the images 1 to 16 are mapped on a composite image area. Although the position of a joining area between two images is calculated, by repeating this calculation, it is possible to obtain a coordinate value of each joining area when all images are arranged in the composite image area.

For example, description will be made using only the x direction. The dimension of each pixel in the x direction is 100 pixels. The upper left of the image 1 is aligned to the original point (x=0) of the composite image area. The joining area between the image 1 and image 2 is between the 80th pixel and 100th pixel of the image 1. The image 2 is between 80th pixel and 180th pixel. The joining area between the image 2 and image 3 is between 70th pixel and 100th pixel of the image 2. The image 3 is between the 150th pixel (80 pixels+70 pixels) and 250th pixel. The joining positions of the images 1 to 16 in the composite image area are represented by the coordinates at the left end of each image from the original point in the x direction. For example, the joining position of the image 1 is 0, the joining position of the image 2 is 80 and the joining position of the image 3 is 150. The joining positions of the images 1 to 16 are calculated as mapped coordinates. Next, images are joined using the image capturing order.

In step S31, determination flags of all images of the composite image area are cleared to 0.1 is set as the image capturing order. In step S32, an image corresponding to a value set in the image capturing order is read. The image of the image capturing order 1 is read. In step S33, a joining position corresponding to the read image in the composite image area is read. In step S34, images are written only in pixels in which the determination flags are 0 from the joining position. When an image corresponding to the image capturing order 1 is written, all determination flags are 0. Then, all pixels of the image area corresponding to the image capturing order 1 are written. In step S35, 1 is written in determination flags corresponding to all pixel positions written in step S34. This is processing which prevents overwriting. Images are written in all image areas corresponding to the image capturing order 1, so that 1 is written as the determination flag in all image areas corresponding to the image capturing order 1.

With the present embodiment, when images are written in pixels, the determination flags are 1 and these pixels are not overwritten thereafter. Thus, images are written according to the image capturing order, written images are not overwritten and the first written image, that is, an image of the earliest image capturing order is left.

In step S36, the image capturing order is added by 1, and, in step S37, whether or not the image capturing order is greater than the final value is decided. When the image capturing order is greater than the final value, processing is finished, and when the image capturing order is equal to or less than the final value, processings of step S32 to step S37 are repeated. When the image capturing order is a final value, the image after synthesis is finished, and any pixel becomes data regarding irradiation of electron beam once.

With the above embodiment, a pattern for forming a panoramic image is extracted from image capturing areas in which the beam irradiation amount is the least to form an image of the earlier order, that is, panoramic image. Hereinafter, a method of extracting a panoramic image forming pattern will be described on the basis of the other criterion.

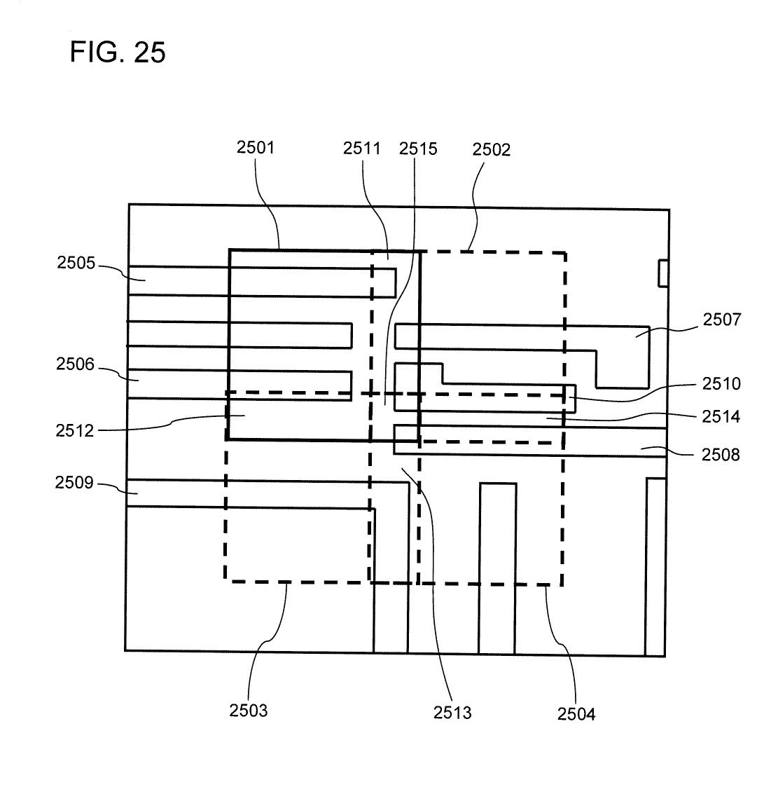

Another example of panoramic image synthesis will be described with reference to FIG. 25. With this example, four image capturing areas (first image capturing area 2501, second image capturing area 2502, third image capturing area 2503 and fourth image capturing area 2504) are set to form a panoramic image. First, the image of the first image capturing area 2501 is captured first, and images of the second, third and fourth image capturing areas are captured (beam scan using SEM). Further, overlapping areas 2511 to 2514 are set to synthesize a panoramic image.

With the present embodiment, from the view point of pattern deformation, a pattern edge included in the first image capturing area 2505 is preferably left for, for example, a pattern 2505 or pattern 2506. However, this is not necessarily the case for, for example, a pattern 2507. For example, the most part of the pattern 2507 is included in the second image capturing area 2502, and only small part of the pattern 2507 is included in the overlapping area 2511 in which the first image capturing area 2501 and second image capturing area 2502 overlap. In this case, part of the pattern 2507 included in the overlapping area 2511 is extracted from the second image capturing area 2502. Consequently, it is possible to acquire a pattern image of less connection parts for the entire pattern 2507.

If the influence such as pattern deformation based on repetition of beam scan is little, there are cases where it is desirable to extract pattern in one field of view (image capturing area). For example, a case will be assumed where the dimension of the pattern 2507 from the left to the right end is measured. Preferably, there is no pattern connection part between one end and the other end which serve as the measurement criterion. Hence, a flag is set in the pattern 2507, and an algorithm of determining image capturing areas is preferably set such that the number of times of connection of this pattern 2507 is as small as possible. By contrast with this, when a gap dimension between the pattern 2506 and pattern 2510 is measured, the gap portion is preferably in one image capturing area. In this case, two patterns are preferably extracted from the first image capturing area 2501. Further, when these image capturing areas from which patterns need to be extracted are determined, exposure simulation may be performed for design data of the pattern. Exposure simulation changes the pattern. Then, an image capturing area is selected such that, for example, a portion in which a dimension value of a pattern is greater than a predetermined value or a portion in which an inter-pattern distance is smaller than a predetermined value is settled in one field of view (image capturing area). In this case, an algorithm is required which determines a field of view (image capturing area) for which a pattern needs to be extracted, on the basis of a decision criterion different from the image capturing order.

Further, in one field of view (image capturing area), when an occupied area to which a certain pattern belongs or a ratio of the pattern area is a predetermined area or more, a field of view (image capturing area) for which a pattern needs to be extracted may be determined on the basis of a decision criterion different from the image capturing order. For example, when occupied areas in the image capturing area 2501 and image capturing area 2502 are compared for the pattern 2507, most of the pattern 2507 is included in the image capturing area 2502. In this case, a pattern only needs to be extracted from the image capturing area 2502. Consequently, it is possible to form for the pattern 2507 an image of a very small connection part.

In design data of a semiconductor device, information related to the size and shape of a pattern is recorded. Consequently, it is possible to set an image capturing area on layout data of design data. Consequently, it is possible to calculate, for example, the area of the pattern included in the image capturing area or overlapping area. This calculation result can be used as a decision criterion different from the above image capturing order.

Further, the position which needs to be measured may be configured to be set in advance on the basis of design data. By this means, it is possible to automatically make the above decision. For the patterns 2508 and 2509, as long as there is no other condition, a field of view (image capturing area) for extracting a pattern according to an image capturing order is preferably selected.

By contrast with this, in case of the pattern 2510, part of the pattern 2510 is in the overlapping area 2515 across four image capturing areas. In this case, if deformation of a pattern needs to be avoided as much as possible, a pattern is extracted from the image capturing area 2501 for the portion to which the overlapping area 2511 belongs, and a pattern is extracted from the image capturing area 2502 for the other portion to synthesize the portions. Further, if a pattern needs to be extracted only from one image capturing area, a pattern only needs to be extracted from the image capturing area 2502. The condition to be set changes depending on the type of a pattern or the measurement purpose of the user of the electron scanning microscope, and therefore is preferably set randomly.

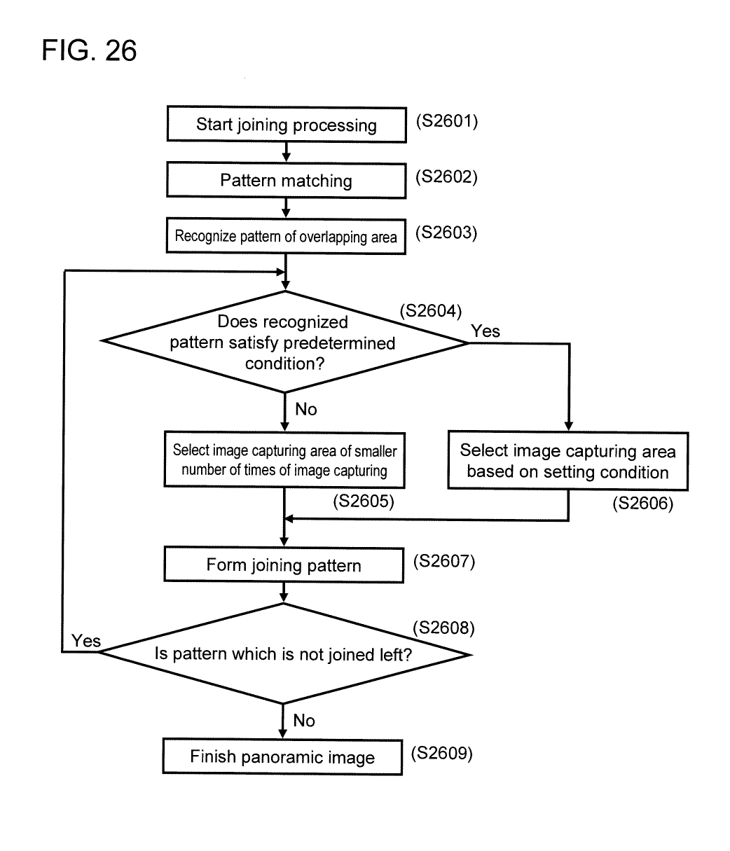

FIG. 26 is a flowchart illustrating process of determining an image capturing area from which a pattern needs to be extracted and forming a panoramic image. First, as in the present embodiment described above, joining processing starts (S2601), and pattern matching is performed for each overlapping area (S2602). Next, referring to design data, a pattern included in the overlapping area is recognized (S2603). Next, whether or not a recognized pattern is a pattern for which a predetermined condition is set is decided (S2604). The predetermined condition is a reference condition set in advance for, for example, measurement position or occupied area described above. For example, an image capturing area in which a pattern occupied area is equal to or more than a predetermined value is selected, and a pattern is extracted from one image capturing area. In case of a pattern for which a predetermined condition is set, an image capturing area is selected on the basis of a predetermined condition, and this pattern is extracted (S2606). When the recognized pattern is not the pattern for which a predetermined condition is set, an image capturing area is selected on the basis of the image capturing order, that is, a smaller number of times of image capturing (S2605).

The pattern is extracted from the image capturing area selected in this way to form a joining pattern (S2607). Next, whether or not there is a pattern for which a joining pattern is not formed is decided (S2608). When there is a pattern for which a joining pattern is not formed, processings in S2604 to S2607 are performed again. When there is no longer a pattern for which a joining pattern is not formed, a panoramic image is finally finished (S2609). According to the above configuration, it is possible to automatically determine an image capturing area from which a pattern needs to be extracted, on the basis of various conditions.

Although the embodiment of the present invention has been described, one of ordinary skill in the art would easily understand that the present invention is by no means limited to the above example, and can be variously changed within the range disclosed in the claims.

1. A composite image creating method for generating one image by connecting a plurality of images obtained by a scanning electron microscope and,
the method comprising:
a step of dividing an image capturing target including a pattern of an electronic device into a plurality of areas, capturing an image per area and storing the captured image in an image memory;
a step of storing an image capturing position of the image;
a step of storing an image capturing order of the image; and
an image synthesizing step of joining a plurality of images retrieved from the image memory on the basis of the image capturing position and the image capturing order,
wherein in the image synthesizing step, images are joined such that joining areas provided in rims of two adjacent images overlap and, of two adjacent images, a joining area of an image of a later image capturing order is removed and a joining area of an image of an earlier image capturing order is left.

2. The composite image creating method according to claim 1, wherein the image capturing order is set such that adjacent areas of a plurality of areas on an image capturing target are not continuously captured.

3. The composite image creating method according to claim 1, wherein an image capturing order of an image in the image synthesizing step is reverse to the image capturing order.

4. The composite image creating method according to claim 1, further comprising:
a step of storing in a deformation information storage device information related to deformation of a pattern of an electronic device due to irradiation of an electron beam; and
a pattern correcting step of correcting the pattern in a joining area of the image on the basis of the information related to the deformation of the pattern.

5. The composite image creating method according to claim 4,
wherein, in the pattern correcting step, a pattern of an image of a later image capturing order is corrected such that deformation of a pattern in a joining area of an image of the later image capturing order is the same as a deformation amount of a pattern in an image of an earlier image capturing order.

6. The composite image creating method according to claim 4,
wherein the information related to the deformation of the pattern includes a number of times of irradiation of an electron beam and a deformation amount of the pattern.

7. The composite image creating method according to claim 4,
wherein the information related to the deformation of the pattern is created on the basis of differential information of an image of a test pattern obtained by capturing images a plurality of times.

8. The composite image creating method according to claim 4,
wherein the information related to the deformation of the pattern is created on the basis of differential information of a joining area of a captured image of a later image capturing order using a joining area of a captured image of an earlier image capturing order as a reference.

9. The composite image creating method according to claim 4,
wherein the pattern correcting step comprises:
a pattern site detecting step of detecting a site of an image of the pattern in a joining area of the image;
a step of reading a deformation amount in the pattern site, from the deformation information storage device; and
a step of correcting the pattern on the basis of the deformation amount of the pattern site.

10. The composite image creating method according to claim 4,
wherein the pattern site detecting step comprises:
a template pattern generating step of generating a template pattern corresponding to the pattern from design data binarizing step of binarizing the joining area; and
a matching step of matching a template obtained in the template pattern generating step and binarized image data obtained in the binarizing step.

11. The composite image creating method according to claim 10,
wherein the pattern site detecting step further comprises:
an expanding step of expanding an outline of the template; and
an expanding step of expanding an outline of the binarized image data; and
the matching step performs matching of the expanded image data.

12. A composite image creating device which comprises: an imaging device which acquires an electron scanning microscope image of an image capturing target including a pattern of an electronic device; an image memory which stores image data acquired by the imaging device; and an image processing unit which connects images stored in the image memory to generate one image,
the composite image creating device comprising:
a storing unit which stores an image capturing position and an image capturing order of an image captured by the imaging device;
a design data storing unit which stores design data of the pattern; and
an image synthesizing unit which joins a plurality of images stored in the image memory to generate one image,
wherein the image synthesizing unit joins a plurality of images retrieved from the image memory on the basis of the image capturing position and the image capturing order such that joining areas provided in rims of two adjacent images overlap, and
further joins images such that, of two adjacent areas, a joining area of an image of a later image capturing order is removed and a joining area of an image of an earlier image capturing order is left.

13. The composite image creating device according to claim 12,
wherein the image capturing order is set such that adjacent areas of a plurality of areas on an image capturing target are not continuously captured.

14. The composite image creating device according to claim 12, wherein an image capturing order of an image in the image synthesizing unit is reverse to the image capturing order.

15. The composite image creating device according to claim 12,
wherein the storing unit stores information related to deformation of a pattern of an electronic device due to irradiation of an electron beam; and
the image synthesizing unit corrects the pattern in a joining area of the image on the basis of the information related to the deformation of the pattern.

16. The composite image creating device according to claim 12,
wherein the image synthesizing unit corrects a pattern of an image of a later image capturing order such that deformation of a pattern in a joining area of an image of the later image capturing order is the same as a deformation amount of a pattern in an image of an earlier image capturing order.

17. The composite image creating device according to claim 15,
wherein the information related to the deformation of the pattern includes a number of times of irradiation of an electron beam and a deformation amount of the pattern.

18. The composite image creating device according to claim 15,
wherein the information related to the deformation of the pattern is created on the basis of differential information of an image of a test pattern obtained by capturing images a plurality of times.

19. The composite image creating device according to claim 15,
wherein the information related to the deformation of the pattern is created on the basis of differential information of a joining area of a captured image of a later image capturing order using a joining area of a captured image of an earlier image capturing order as a reference.

20. An electron scanning microscope device which comprises: an electron scanning microscope; and a composite image creating device which connects images using the electron scanning microscope to generate one image,
wherein the composite image creating device which comprises: an image memory which stores an electron scanning microscope image of an image capturing target including a pattern of an electronic device; an image processing unit which connects images stored in the image memory to generate one image;
a storing unit which stores an image capturing position and an image capturing order of an image captured by the electron scanning microscope; a design data storing unit which stores design data of the pattern; and an image synthesizing unit which joins a plurality of images stored in the image memory to generate one image; and
the image synthesizing unit joins a plurality of images retrieved from the image memory on the basis of the image capturing position and the image capturing order such that joining areas provided in rims of two adjacent images overlap, and
further joins images such that, of two adjacent areas, a joining area of an image of a later image capturing order is removed and a joining area of an image of an earlier image capturing order is left.
